(19) United States
(12) Patent Application Publication
(10) Pub. No.: US 2019/0068009 A1
(43) Pub. Date: Feb. 28, 2019

(54) STATOR, STATOR MANUFACTURING METHOD AND MOTOR

(71) Applicant: Nidec Corporation, Kyoto (JP)

(72) Inventors: Yasuaki NAKAHARA, Kyoto (JP); Takayuki MIGITA, Kyoto (JP); Hiroshi KITAGAKI, Kyoto (JP); Takeshi HONDA, Kyoto (JP); Hisashi FUJIHARA, Kyoto (JP)

(21) Appl. No.: 16/170,170

(22) Filed: Oct. 25, 2018

Related U.S. Application Data
(63) Continuation of application No. PCT/JP2017/031387, filed on Aug. 31, 2017.

(30) Foreign Application Priority Data
Sep. 2, 2016 (JP) 2016-172339

(51) Int. Cl. H02K 1/14; H02K 15/02

(52) U.S. Cl. CPC H02K 1/146; H02K 15/022

(57) ABSTRACT

A stator includes an annular core including a central axis. The core includes core pieces including first and second laminate members. The first laminate member includes a first tooth portion extending in a radial direction, and a first core back portion connected to the first tooth portion and extending in a circumferential direction. The second laminate member includes a second tooth portion extending in a radial direction, and a second core back portion connected to the second tooth portion and extending in a circumferential direction. Positions of circumferential ends of the first core back portion are different from positions of circumferential ends of the second core back. The first core back portion includes a first protrusion on one side thereof in the first circumferential direction. The first protrusion is in contact with one of the core pieces adjacent thereto at one point.

### CROSS REFERENCE TO RELATED APPLICATIONS

This application claims the benefit of priority to Japanese Patent Application No. 2016-172339 filed on Sep. 2, 2016 and is a Continuation Application of PCT Application No. PCT/JP2017/031387 filed on Aug. 31, 2017. The entire contents of each application are hereby incorporated herein by reference.

### BACKGROUND OF THE INVENTION

### 1. Field of the Invention

The present invention relates to a stator, a stator manufacturing method, and a motor.

### 2. Description of the Related Art

A stator of a motor includes a plurality of teeth radially installed thereon, and an annular part connecting radially outer sides of the teeth in an annular shape. In the stator, an inclined part is formed on an end portion of each core piece of each divided laminate core, and pairs of core pieces with different shapes are alternately laminated with one another.

In this stator, a circular arc-shaped protrusion is formed at one end thereof in a circumferential direction corresponding to a divided annular part of a first laminate member, a circular arc-shaped recess is formed at the other end thereof in the circumferential direction, a circular arc-shaped recess is formed at one end thereof in the circumferential direction corresponding to a divided annular part of a second laminate member, and a circular arc-shaped protrusion is formed at the other end thereof in the circumferential direction.

### SUMMARY OF THE INVENTION

According to an exemplary preferred embodiment of the present invention, a stator includes a core with an annular shape having a center that is a central axis. The core includes a core piece in which at least a first laminate member and a second laminate member are laminated. The first laminate member includes a first tooth portion extending in a radial direction and a first core back portion connected to a radially outer side of the first tooth portion and extending in a circumferential direction. The second laminate member includes a second tooth portion extending in a radial direction and a second core back portion connected to a radially outer side of the second tooth portion and extending in a circumferential direction. Positions of both circumferential ends of the first cover back portion are different from positions of both circumferential ends of the second core back portion. The first core back portion includes a first protrusion provided on one side thereof in the circumferential direction. The first protrusion is in contact with the core piece adjacent thereto at one point.

According to an exemplary preferred embodiment of the present invention, since a core piece is in contact with an adjacent core piece at one point, a frictional resistance at a portion at which the core pieces are connected is decreased. Thus, in a manufacturing process, when a connection portion of the core back portion is rotated to wind a conductive wire around a tooth portion of the core piece, the conductive wire is able to be easily wound without overlapping while the core pieces are rotated.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view of a motor according to a preferred embodiment of the present invention.

FIG. 2 is a plan view of a laminate member of a core piece according to a preferred embodiment of the present invention.

FIG. 3 is a plan view of laminate members of laminated core pieces according to a preferred embodiment of the present invention.

FIG. 4 is a plan view of annularly connected core pieces according to a preferred embodiment of the present invention.

FIG. 5 is an enlarged view of a connection portion of adjacent core pieces according to a preferred embodiment of the present invention.

FIG. 6 is a plan view showing an area, in which core back portions of adjacent core pieces according to a preferred embodiment of the present invention overlap each other in a lamination direction.

FIG. 7 is a cross-sectional view of a connection portion of adjacent core pieces according to a preferred embodiment of the present invention.

FIG. 8 is a plan view of a core piece according to a modified preferred embodiment of the present invention.

FIG. 9 is a cross-sectional view of a connection portion of core pieces according to a modified preferred embodiment of the present invention.

FIG. 10 is a flowchart showing a process of manufacturing a stator according to a preferred embodiment of the present invention.

FIG. 11 is a view showing a laminate member formed on a plate member used in a process of manufacturing a stator according to a preferred embodiment of the present invention.

FIG. 12 is a plan view showing laminate members of core pieces in a process of manufacturing a stator according to a preferred embodiment of the present invention.

FIG. 13 is a plan view showing a divided stator having a coil formed by winding a conductive wire around teeth of a core piece in a process of manufacturing a stator according to a preferred embodiment of the present invention.

### DETAILED DESCRIPTION OF THE PREFERRED EMBODIMENTS

Hereinafter, preferred embodiments of the present invention will be described in detail with reference to the accompanying drawings. The preferred embodiments described below are only exemplary examples of the present invention, but the technical scope is not limited thereby. Further, the same reference numerals may be assigned to the same components, and the descriptions thereof may be omitted.

The exemplary preferred embodiments of the present invention relate to a configuration of a stator (referred to as a “core piece”) used in a motor and a method of manufacturing the stator. In the description, the term “core piece” refers to an element including a tooth portion around which a conductive wire is wound and an annularly connected core back portions. The term “core” refers to a group of a plurality of annularly connected core pieces. The divided stator refers to a core piece around which the conductive wire is wound. The term “stator” refers to a group of a plurality of divided stators annularly connected. Further, each layer of the core piece, which defines the core by being laminated, refers to a “laminate member.” Further, the term “laminate member” does not indicate only a first member of members of the core piece, but may include a plurality of members having the same or similar shapes and consecutively laminated.

Further, for convenience of description in the specification, in laminate members laminated in a manufacturing process, a direction in which the laminate members are laminated refers to an “upper side” or an “upper direction,” and a direction in which laminate members, which are already laminated, are positioned refers to a “lower side” or a “lower direction.” In most cases, the lower side opposing the upper side is positioned on a lower side in a gravity direction. Further, a direction in which the laminate members of the core piece are laminated refers to a “lamination direction.” In the following description, the lamination direction is parallel to a central axis of rotation of the motor, but the lamination direction and the central axis are not necessarily parallel to each other.

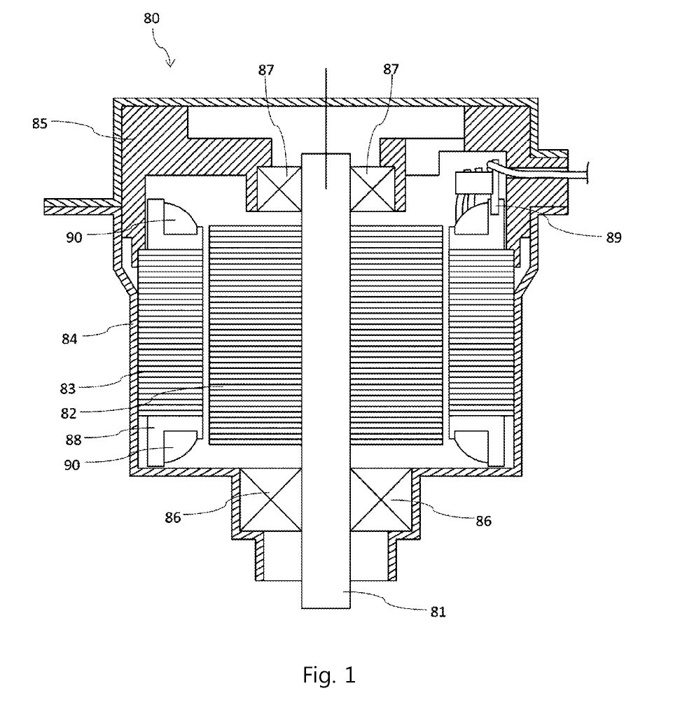

FIG. 1 is a cross-sectional view of a motor 80 of one preferred embodiment of the present invention. As shown in FIG. 1, the motor 80 preferably includes a shaft 81, a rotor 82, a stator 83, a housing 84, a bearing holder 85, a first bearing 86, a second bearing 87, an insulator 88, a coil-drawing line 89, a coil 90, and the like. The shaft 81 and the rotor 82 are preferably integrated with each other by, for example, the shaft 81 being press fit through the rotor 82. The shaft 81 has a cylindrical or substantially cylindrical shape having a center that is a central axis extending in one direction. The rotor 82 is positioned at a middle of the shaft 81. The rotor 82 is rotatable about the stator 83. The stator 83 is disposed to surround the rotor 82 in an axial direction. The stator 83 includes the coil 90 which is preferably formed by winding a conductive wire around the core of the stator 83. The housing 84 is engaged with an outer circumferential surface of the stator 83 and accommodates the shaft 81, the rotor 82, the stator 83, the bearing holder 85, the first bearing 86, the second bearing 87, the insulator 88, the coil-drawing line 89, and the coil 90 which compose the motor 80. The bearing holder 85 supports the second bearing 87. The bearing holder 85 is engaged with the housing 84. The first bearing 86 is preferably disposed at a lower portion of the housing 84 and supports one side of the shaft 81. The second bearing 87 supports the other side of the shaft 81. The insulator 88 is disposed between the stator 83 and a conductive wire of the coil 90 to insulate the stator 83 and the conductive wire of the coil 90.

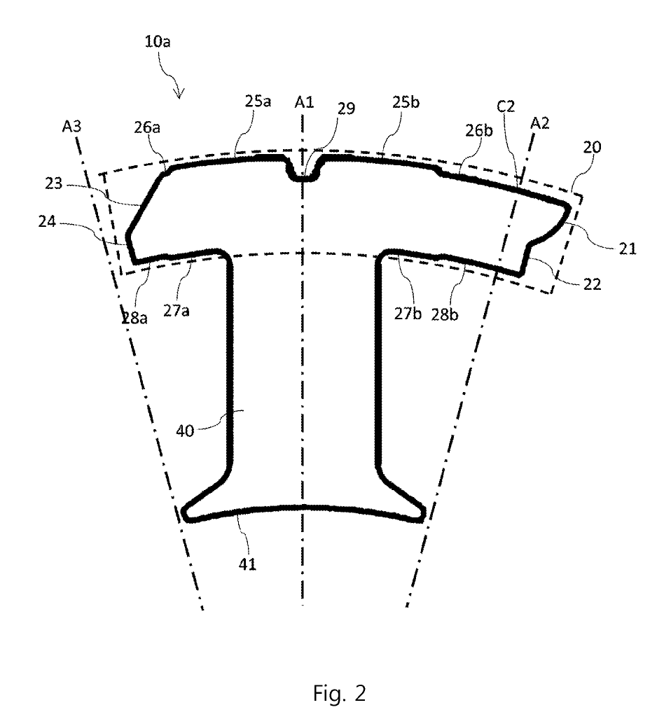

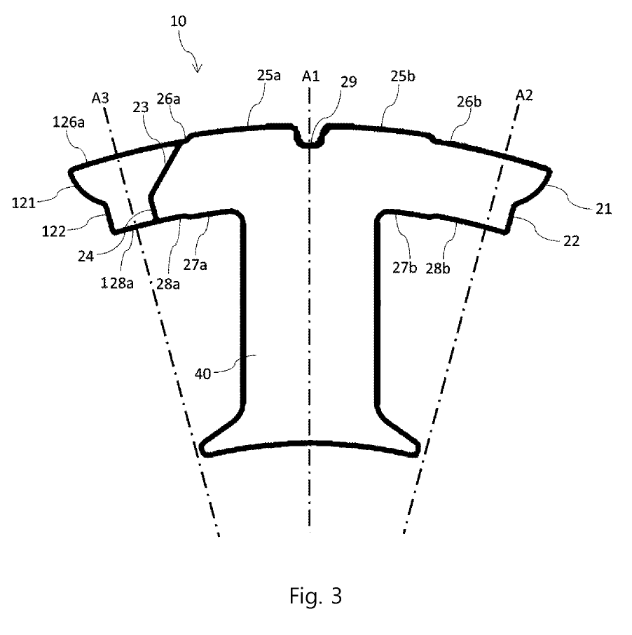

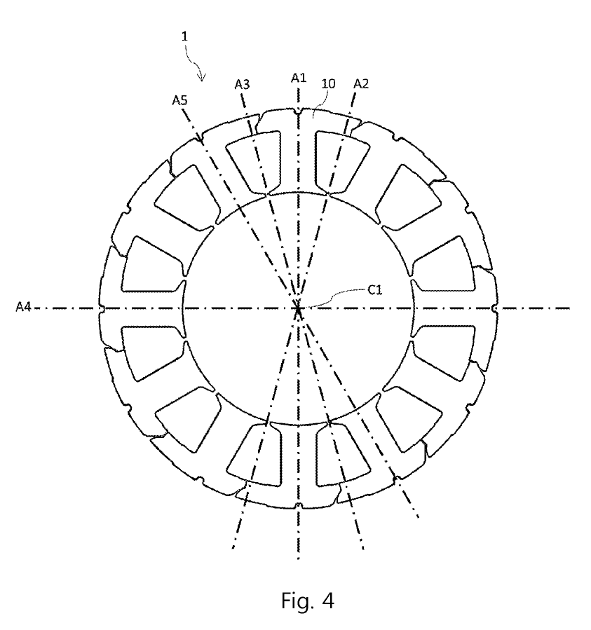

FIG. 2 is a plan view of one laminate member 10a of a core piece 10 which defines the stator 83. FIG. 3 is a plan view of the laminated core pieces 10. FIG. 4 is a plan view of a core 1 in a state in which the core pieces 10 are annularly connected.

As shown in FIG. 4, a center point of a circle of an outer circumferential surface or an inner circumferential surface defined by the core 1 is C1. Straight lines A1, A2, and A3 shown in FIGS. 2 and 3 each are lines extending in a radial direction through the center point C1. An inner angle between the straight line A1 and the straight line A2 and an inner angle between the straight line A1 and the straight line A3 are preferably about 15°, for example. An inner angle between tooth portions 40 of adjacent core pieces 10 is preferably about 30°, for example. An inner angle between the tooth portions 40 of the adjacent core pieces 10, an inner angle between the straight lines A1 and A2, and an inner angle between the straight lines A1 and A3 vary according to the number of core pieces 10 forming the core 1. The core 1 according to the present preferred embodiment of the present invention preferably includes the twelve core pieces 10, and thus, as described above, each of the inner angles between the tooth portions 40 of the adjacent core pieces 10 is preferably about 30°. Further, the number of core pieces 10 of the core 1 may be arbitrarily changed as desired.

As shown in FIG. 2, the laminate member 10a of the core piece 10 includes the tooth portion 40 and the core back portion 20. The core piece 10 is preferably formed by laminating the plurality of laminate members 10a with a predetermined thickness. The tooth portion 40 is linearly symmetrical with respect to the straight line A1 passing through the center point C1. The tooth portion 40 has a shape in which an end on an inner side in a radial direction extends in a circumferential direction, and has an inner circumferential surface 41 on the inner side in the radial direction.

As shown in FIG. 3, one laminate member and another laminate member of the core piece 10 are laminated so that the tooth portion 40 does not protrude. Since circumferential lengths of one circumferential end of one laminate member and another circumferential end of another laminate member are different from each other, one side protrudes from another side.

The core back portion 20 is an element defining an annular portion of the core 1. The core back portion 20 is preferably connected with a radially outer side of the tooth portion 40 and has a shape extending in a circumferential direction.

The core back portion 20 includes a circular arc-shaped protrusion 21 and a radially straight portion 22 formed at one end thereof in the circumferential direction. The radially straight portion 22 has a shape of a straight or substantially straight line extending in a radial direction through the center point C1. The radially straight portion 22 protrudes outward from the straight line A1 in a circumferential direction. The circular arc-shaped protrusion 21 has a shape protruding circumferentially outward of a radially straight line passing through the center point C1 and the radially straight portion 22. The circular arc-shaped protrusion 21 preferably has a circular arc or substantially circular arc shape partially overlapping a circle having a center that is an intersection point C2 between the straight line A2 and an outer circumferential recess 26b of the core back portion 20. An end on a circumferential inner side of the circular arc-shaped protrusion 21 is connected with an end on the circumferential outer side of the radially straight portion 22, and the circular arc-shaped protrusion 21 and the circumferential end of the radially straight portion 22 become one circumferential end of the core back portion 20.

Further, the circular arc-shaped protrusion 21 may not necessarily have a circular arc or substantially arc shape if so desired. For example, the core back portion 20 may be a protrusion with an arc shape of an ellipse or a gently curved protrusion instead of the circular arc-shaped protrusion 21. But a portion corresponding to the circular arc-shaped protrusion 21 of one end of the core back portion 20 is in contact with a contact portion 23 of an adjacent core piece at one point.

The core back portion 20 preferably includes the contact portion 23 and a radially straight portion 24 provided at the other end thereof in the circumferential direction. Like the radially straight portion 22, the radially straight portion 24 preferably has a shape extending in a radial direction through the center point C1. Unlike the radially straight portion 22, the radially straight portion 24 has a shape of being recessed circumferentially inward of the straight line A3. The contact portion 23 preferably has a straight shape with an inclined surface recessed circumferentially inward of the radially straight portion 24. An inner angle between the radially straight portion 22 and the contact portion 23 is preferably about 135°. An end on a circumferential inner side of the contact portion 23 is connected with an end on a circumferential outer side of the radially straight portion 24, and the contact portion 23 and one circumferential end of the radially straight portion 24 become the other circumferential end of the core back portion 20.

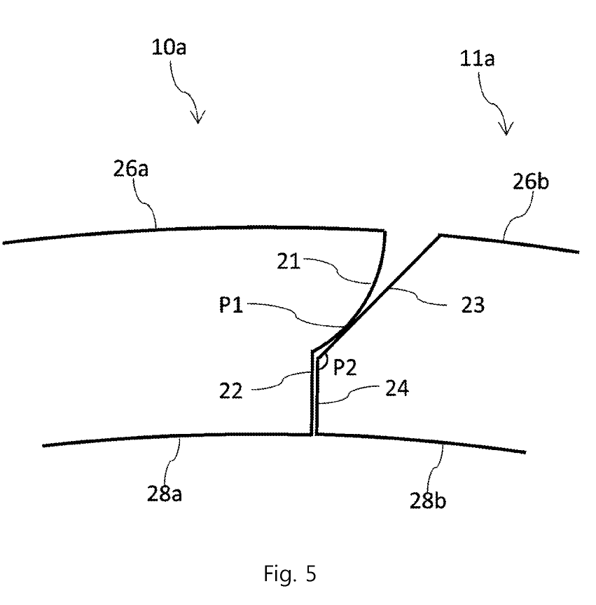

FIG. 5 is an enlarged view of a connection portion of laminate members 10a and 11a of the core pieces 10 and 11 adjacent to each other. As shown in FIG. 5, an inner angle P2 between the radially straight portion 24 and the contact portion 23 is preferably about 135°.

Further, the contact portion 23 may not necessarily have a straight line or substantially straight line shape. For example, the contact portion 23 may be a shape of a circular arc-shaped or substantially circular arc-shaped protrusion, or recess or a curved portion. But a portion corresponding to the contact portion 23 of the other end of the core back portion 20 is in contact with the circular arc-shaped protrusion 21 of the adjacent core piece at one point. The contact portion 23 refers to a linear recess as a representation corresponding to the circular arc-shaped protrusion.

As shown in FIG. 5, one end of the laminate member 10a of the core piece 10 is preferably in contact with the other end of the laminate member 11a of the adjacent core piece 11. Specifically, the circular arc-shaped protrusion 21 of the core piece 10 and the contact portion 23 of the core piece 11 are in contact with each other at one contact point P1. The radially straight portion 22 of the core piece 10 and the radially straight portion 24 of the core piece 11 are spaced apart from each other. But the radially straight portion 22 of the core piece 10 and the radially straight portion 24 of the core piece 11 are not necessarily spaced apart from each other and may be in contact with each other.

As described above, in the core piece 10 and the core piece 11 which are adjacent to each other, the circular arc-shaped protrusion 21 of the laminate member 10a of the core piece 10 and the contact portion 23 of the laminate member 11a of the core piece 11 are in contact with each other at one point. When the core piece 10 rotates outward of the radial direction with respect to the core piece 11, the radially straight portion 22 and the radially straight portion 24 are not in contact with each other, but the circular arc-shaped protrusion 21 and the contact portion 23 are in contact with each other at one point. Even when the core piece 11 and the core piece 10 relatively rotate, the core piece 10 and the core piece 11 are in contact with each other at one point, and thus a frictional resistance between the core piece and the core piece 11 decreases. Therefore, compared to a configuration in which core pieces adjacent to each other are in surface contact with each other or in contact with each other at a plurality of points as in the conventional art, the core pieces can rotate while connected with each other.

Further, when the core piece 10 rotates with respect to the core piece 11, a center of rotation is a center C2 of a circular arc of the circular arc-shaped protrusion 21. In the laminate members of the core piece 10, since the center C2 coincides with a lamination direction, the core piece 10 may smoothly rotate about the center C2 as an axis.

Further, in the laminate members 10a and 11a of the core pieces 10 and 11, an inner angle between the radially straight portion 24 and the contact portion 23 is preferably about 135°, and thus the core piece 10 may rotate within a wide range when rotating with respect to the core piece 11 while being in contact with the core piece 11 at one point. Further, the inner angle P2 is not necessarily limited to about 135° and may be changed within a range of about 130° to about 140°. Even when the inner angle P2 is an arbitrary angle in a range of about 130° to about 140°, the core pieces can be rotated in a sufficiently wide range while being in contact with each other at one point.

An outer circumferential surface of the core back portion 20 is engaged with a housing (not shown) when a motor is assembled. The core back portion 20 includes a central recess 29, outer circumferential surfaces 25a and 25b, and outer circumferential recesses 26a and 26b provided at an outer circumferential portion thereof.

The central recess 29 is incised which is recessed inward in the radial direction is arranged at a position at which an outer circumferential surface of the core back portion 20 and the straight line A1 intersect with each other. The central recess 29 extends in a groove shape in a vertical direction in which the laminate members are laminated.

Each of the outer circumferential surfaces 25a and 25b preferably has a circular arc or substantially circular arc shape including a center that is the center point C1. The outer circumferential surfaces 25a and 25b are connected with both circumferential sides of the central recess 29. The outer circumferential surfaces 25a and 25b are portions which are in contact with the inner circumferential surface of the housing while the stator including the core 1 around which the conductive wire is wound is engaged with an inner side of the housing.

The outer circumferential recesses 26a and 26b are connected with circumferential end sides on the outer circumferential surfaces 25a and 25b. The outer circumferential recesses 26a and 26b are recessed from the outer circumferential surfaces 25a and 25b inward in a radial direction. The outer circumferential recesses 26a and 26b include a circular arc or substantially circumferential shape having a smaller diameter than that of the outer circumferential surfaces 25a and 25b and having the center point C1 the same as that of the outer circumferential surfaces 25a and 25b. When the stator is fitted to an inner side of the housing, the outer circumferential recesses 26a and 26b are not in contact with an inner circumferential surface of the housing, and thus gaps are defined between the inner circumferential surface of the housing and the outer circumferential recesses 26a and 26b.

The outer circumferential surface of the core back portion 20 of the core piece 10 is preferably engaged with the housing as a stator, as described above, the outer circumferential surfaces 25a and 25b are in contact with an inner circumferential surface of the housing, and the central recess 29 and the outer circumferential recesses 26a and 26b are not in contact with the inner circumferential surface of the housing. Therefore, accuracy of a size of the outer circumferential surface of the core back portion 20 increases. Further, the core back portion 20 may not necessarily have the outer circumferential recesses 26a and 26b. When the core back portion 20 has a shape having the outer circumferential recesses 26a and 26b, dimensions of the outer circumferential surfaces 25a and 25b more effectively increase.

The core back portion 20 preferably includes inner circumferential surfaces 27a and 27b and inner circumferential recesses 28a and 28b provided on an inner circumferential surface thereof. The inner circumferential surfaces 27a and 27b have a circular arc or substantially circular arc shape having a center that is the center point C1. The inner circumferential surfaces 27a and 27b are connected with both circumferential sides of the tooth portion 40. The inner circumferential recesses 28a and 28b are connected with circumferential end sides of the inner circumferential surfaces 27a and 27b. The inner circumferential recesses 28a and 28b are recessed from the inner circumferential surfaces 27a and 27b outward in the radial direction. The inner circumferential recesses 28a and 28b preferably include a circular arc or substantially circular arc shape having an inner diameter smaller than that of the inner circumferential surfaces 27a and 27b having the center that is the center point C1 the same or substantially the same as that of the inner circumferential surfaces 27a and 27b.

As shown in FIG. 3, when the core piece 10 including a plurality of laminate members which are laminated is viewed from above, since positions of both circumferential ends of the core back portion 20 are different from each other among the laminate members, the laminate member disposed on a lower side is partially shown. When viewed from above, a circular arc-shaped protrusion 121, a radially straight portion 122, an outer circumferential recess 126a, and an inner circumferential recess 128a of the laminate member disposed below the laminate member disposed on the top are shown at the contact portion 23, which is defined short in a circumferential direction of the core back portion 20, and a circumferential outer side of the radially straight portion 24. The circular arc-shaped protrusion 121, the radially straight portion 122, the outer circumferential recess 126a, and the inner circumferential recess 128a of the laminate members of the core piece 10 overlap an adjacent core piece in a lamination direction.

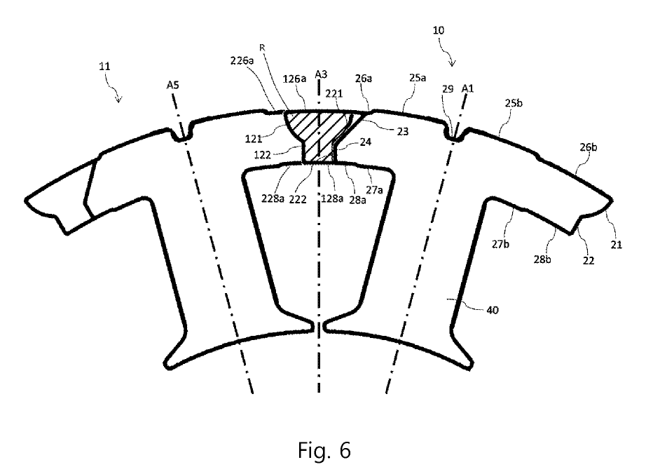

FIG. 6 is a view showing the core back portions 20 of the core pieces 10 and 11 adjacent to each other overlap each other in a lamination direction, and particularly, a view showing an overlapping area. A circular arc-shaped protrusion 221, a radially straight portion 222, an outer circumferential recess 226a, and an inner circumferential recess 228a of the laminate member of the core piece 11 are preferably laminated on the circular arc-shaped protrusion 121, the radially straight portion 122, the outer circumferential recess 126a, and the inner circumferential recess 128a of the laminate member of the core piece 10. The laminate member of the core piece 10 is disposed under the laminate member of the core piece 11. As shown in FIG. 6 with inclined lines, the core piece 10 and the core piece 11 overlap in an area R. A boundary of the area R is determined by the circular arc-shaped protrusion 221, the radially straight portion 222, the outer circumferential recess 226a, and the inner circumferential recess 228a, which are laminate members of the core piece 11 positioned on an upper side, and the circular arc-shaped protrusion 121, the radially straight portion 222, the outer circumferential recess 226a, and the inner circumferential recess 228a, which are laminate members of the core piece 10 positioned on a lower side. But the outer circumferential recess 226a and the inner circumferential recess 228a, the outer circumferential recess 226a, and the inner circumferential recess 228a preferably overlap each other in the lamination direction.

For example, an area of the area R is greater than an area of a circumferentially cross-sectional area of the core back portion 20 at a position of the straight line A3. Further, the cross-section of the core back portion 20 is calculated by multiplying a circumferential length of the core back portion 20 and a thickness of the laminate member. The reason why the area R is formed as described above is as follows.

One circumferential end of each of the laminate members of the core piece 10 is in contact with the other circumferential end of each of the laminate members of the core piece 11 at one point. For this reason, as compared with when one circumferential end of the core piece 10 is in surface contact with the other circumferential end of the core piece 11, a magnetic path is defined by circumferential ends of the core pieces 10 and 11 so that an amount of magnetic flux flowing therein is narrow. Therefore, the area greater than or equal to the magnetic path which is narrowed due to the area R is able to be secured. Further, since the radially straight portion 22 and the radially straight portion 24 are not in contact with each other in a circumferential direction in an assembled state, the magnetic path is not provided at a position at which the radially straight portion 22 and the radially straight portion 24 are not in contact with each other.

Even when one circumferential end of the laminate member of the core piece 10 is not in contact with the other circumferential end of the laminate member of the core piece 11 adjacent thereto, is in surface contact therewith, or is in contact with at a plurality of points, the magnetic path is defined in the area R, and thus the magnetic property is improved.

Further, it is preferable that the area R be less than or equal to about 5 times the circumferential cross-sectional area of the core back portion 20. Therefore, an area in which the core back portions 20 of the adjacent core piece 10 overlap in the lamination direction is sufficiently secured, and thus a sufficient magnetic path is able to be secured. Further, because a frictional resistance is prevented from being excessively generated in the lamination direction of the core back portion 20 of the adjacent core piece 10, the adjacent core pieces are able to rotate in a manufacturing process.

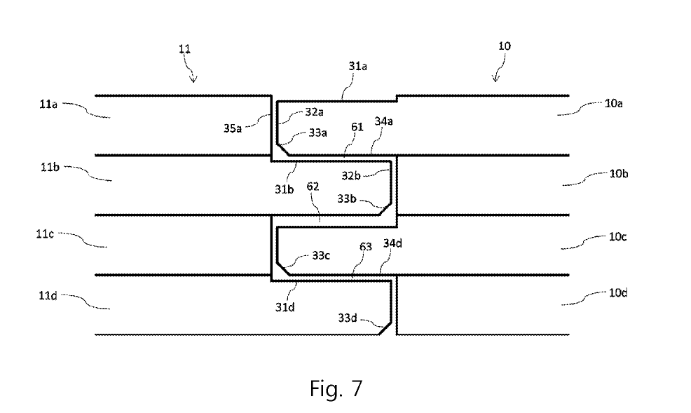

FIG. 7 is a cross-sectional view of the connection portion of the core pieces 10 and 11 adjacent to each other. As shown in FIG. 7, the core piece 10 is preferably defined by laminate members 10a to 10d which are laminated. The core piece 11 is preferably defined by laminate members 11a to 11d which are laminated. Ends of the core piece 10 and the core piece 11 face each other and preferably have uneven portions. The uneven portion of the end of the core piece 10 is engaged and connected with the uneven portion of the end of the core piece 11.

An end 32a of the radially straight portion 22 or the circular arc-shaped protrusion 21 is preferably provided at a circumferential end of the laminate member 10a of the core piece 10. An end 35a of the radially straight portion 24 or the contact portion 23 is preferably defined at a circumferential end of the laminate member 11a of the core piece 11 to face the end 32a. An upper recess 31a, which is more recessed from an upper surface of a circumferential inner side of the core piece 10, is provided at an upper side of the circumferential inner side of the end 32a. A lower surface 34a is positioned under the circumferential inner side of the end 32a. An inclination 33a is provided between the end 32a and the lower surface 34a. When viewed from above, the inclination 33a is positioned at the circular arc-shaped protrusion 121 protruding from the upper laminate member in the circumferential direction, the radially straight portion 122, the outer circumferential recess 126a, and the inner circumferential recess 128a (see FIG. 6). The inclination 33a is preferably formed by a chamfering process in the manufacturing process, for example.

The laminate member of the core piece 10 is preferably formed by punching a plate member in the manufacturing process, for example. In this case, a burr protruding downward is formed on a lower surface of the laminate members. Since the burr causes interference in accurate lamination when the laminate members are laminated, the above-described chamfering is performed. Further, the inclination 33a is formed by the chamfering, and thus the core pieces are able to be smoothly rotated. Further, the lower side of the core piece 10 may be formed to have a curved shape instead of the inclination 33a.

A gap 61 may be defined between a lower surface 34a of the laminate member 10a and an upper recess 31b of the laminate member lib in a lamination direction. Similarly, a gap 62 is defined between the laminate member lib and the laminate members 10c, and a gap 63 is provided between the laminate member 10c and the laminate member 11d. The gaps 61, 62, and 63 preferably have a distance of greater than or equal to about 5 μm to less than or equal to about 20 μm, for example, so that magnetic paths are appropriately defined. Further, in order to form the more appropriate magnetic path, the gaps preferably have a distance of greater than or equal to about 5 μm to less than or equal to about 10 μm, for example.

The gaps 61, 62, and 63 preferably have long and short distances rather than the same distance. For example, in the present preferred embodiment, the gaps 61 and 63 have a distance of about 5 μm, and the gap 62 has a distance of about 10 μm. An effective magnetic path is secured at a portion at which a distance in the lamination direction of the laminated portion of the adjacent core pieces is short, and a frictional resistance decreases at a portion at which a distance in the lamination direction is long. Therefore, when the effective magnetic path is provided, the magnetic property is secured, and the core pieces are able to be easily rotated in the manufacturing process.

Further, a lower recess is preferably provided on a lower side of a circumferential inner side of the circumferential end 32a of the laminate member 10a, similar to the upper recess 31a. Further, the lower recess may be provided on the laminate member 10a instead of the upper recess 31a.

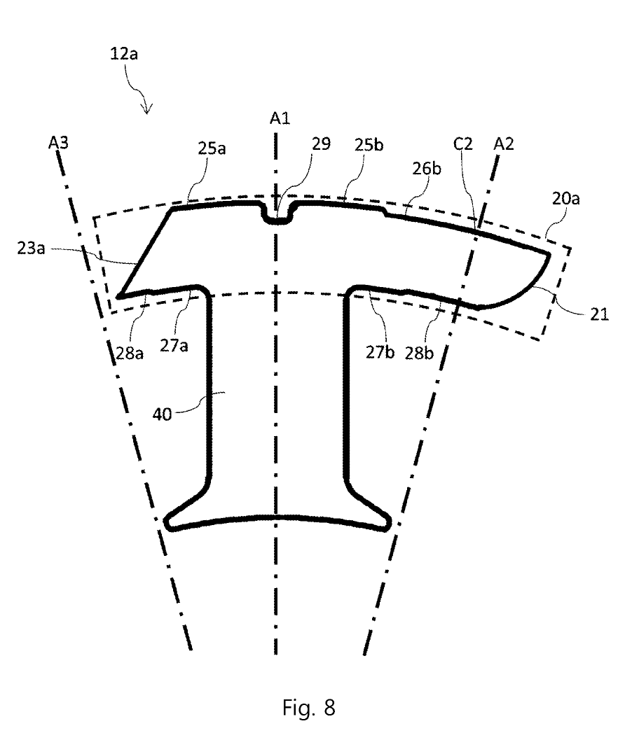

FIG. 8 is a plan view of laminate members 12a defining a core piece 12 as a modified preferred embodiment according to the present invention. As shown in FIG. 8, the shapes of both circumferential ends of the laminate member 12a of the modification are different from those of the laminate member 10a (see FIG. 2) according to the above-describe preferred embodiment of the present invention.

Specifically, the laminate member 12a has a circular arc-shaped protrusion 21a provided at one circumferential end of the core back portion 20a thereof. The laminate members 12a preferably includes a contact portion 23a defined at the other circumferential end of the core back portion 20a. The laminate member 12a of the modification does not have radially straight portions defined at both ends thereof.

Even in the case of this configuration, ends in a circumferential direction of the adjacent core pieces are in contact with each other at one point, and the same effect as that of the above-described preferred embodiment is obtained. The core piece 12 of the modification is used, and thus the laminate members of the core piece are able to be easily manufactured.

However, as described in the above-described preferred embodiment, when the laminate member includes the radially straight paths 22 and 24, and one core piece is rotated in a direction in which an inner side in the radial direction gets close to the other core piece, the radially straight paths 22 and 24 come into contact with each other. Therefore, one core piece is able to be prevented from rotating in a direction in which the radially inner side gets close to the other core piece.

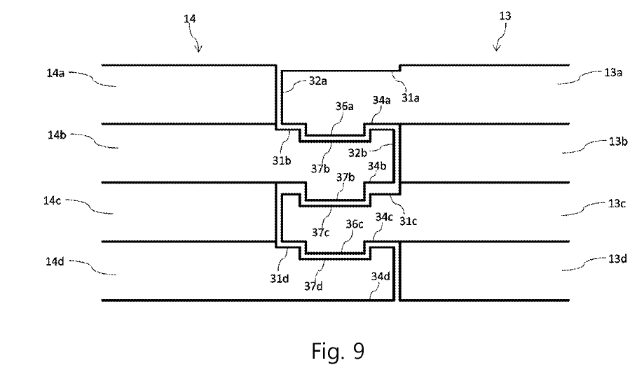

FIG. 9 is a cross-sectional view of a connection portion of core pieces 13 and 14 in a modified preferred embodiment according to the present invention. As shown in FIG. 9, when compared to the core pieces 10 and 11 (see FIG. 7) according to the above-described preferred embodiment, the core pieces 13 and 14 of the modification preferably have a different lamination shape in the vicinity of circumferential ends thereof.

Specifically, a lower protrusion 36a additionally protruding downward from a lower surface 34a is preferably defined on a lower side of a circumferential inner side of the end 32a of a laminate member 13a of the core piece 13. A second upper recess 37b, which overlaps the lamination member 13a in the lamination direction and is more recessed than the upper recess 31b, is provided at an upper side of a circumferential inner side of the end 32b of a laminate member 14b of the core piece 14. The lower protrusion 36a and the second upper recess 37b face each other in a lamination direction and are engaged with each other. Therefore, uneven portions engaged with each other are defined at a portion at which laminate members of the adjacent core pieces 13 and 14 overlap each other in the lamination direction, and thus the core piece 13 and the core piece 14 are prevented from being separated.

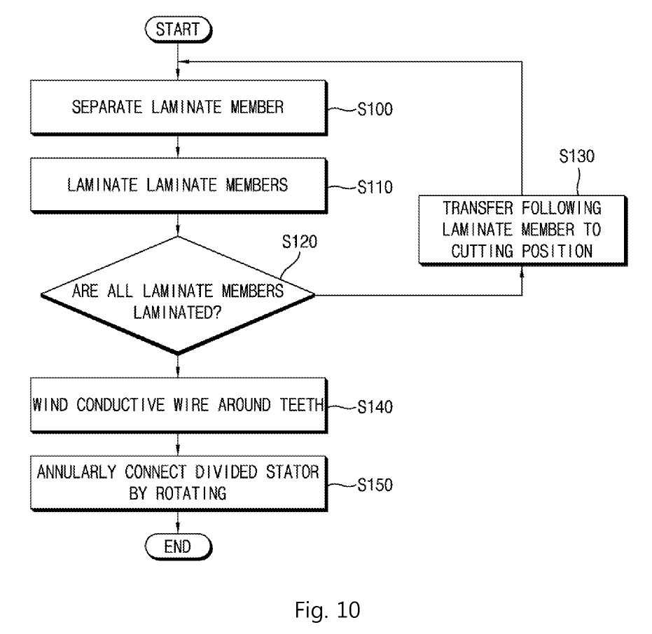

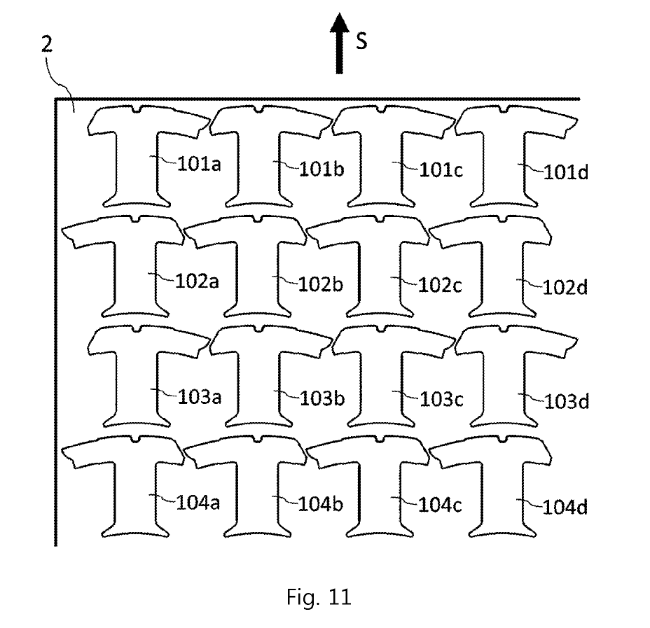

A method of manufacturing a stator of a preferred embodiment of the present invention will be described with referent to FIGS. 10 to 13. Further, although a plurality of the stacked laminate plate members are arranged in a circumferential direction, to form annularly connected cores in practice, only a portion of them are shown in FIGS. 11 to 13, and the others are omitted for the sake of simplicity. Hereinafter, in a plane which is horizontal to a gravity direction, a direction horizontal to a transfer direction of the plate member refers to a “transverse direction.”

FIG. 10 is a flowchart showing a process of manufacturing a stator according to a preferred embodiment of the present invention. In the process of manufacturing the stator, a process of separating a laminate member from a plate member, which is a base material, (S100) is performed first. When the laminate member is separated, the separated laminate member is laminated on the laminate member (S110).

FIG. 11 is a view showing laminate members 101a, 101b, 101c, 101d, 102a, 102b, 102c, 102d, 103a, 103b, 103c, 103d, 104a, 104b, 104c, and 104d of core pieces provided on a plate member 2. The laminate members 101a, 101b, 101c, and 104d are arranged in each lamination layer. The laminate members 101a, 101b, 101c, and 1041 are arranged in a first layer, the laminate members 102a, 102b, 102c, and 102d are arranged in a second layer, the laminate members 103a, 103b, 103c, and 103d are arranged in a third layer, and the laminate members 104a, 104b, 104c, and 104d are arranged in a fourth layer, and thus the core piece is formed. In the process of separating the laminate members, the laminate members in the same layer are simultaneously or sequentially separated.

When all of the laminate members are not laminated (N of S120), the plate member 2 is transferred in a transfer direction S (see FIG. 11), then the laminate members to be laminated are transferred to a separation position (S130). For example, before separation of the laminate members 102a, 102b, 102c, and 102d in the second layer is performed, the laminate members 102a, 102b, 102c, and 102d formed on the plate member 2 are positioned right above the separated laminate members 101a, 101b, 101c, and 101d in the first layer. Further, a separation of the laminate members 102a, 102b, 102c, and 102d is performed (S100) so that the laminate members 102a, 102b, 102c, and 102d are laminated on the laminate members 101a, 101b, 101c, and 101d.

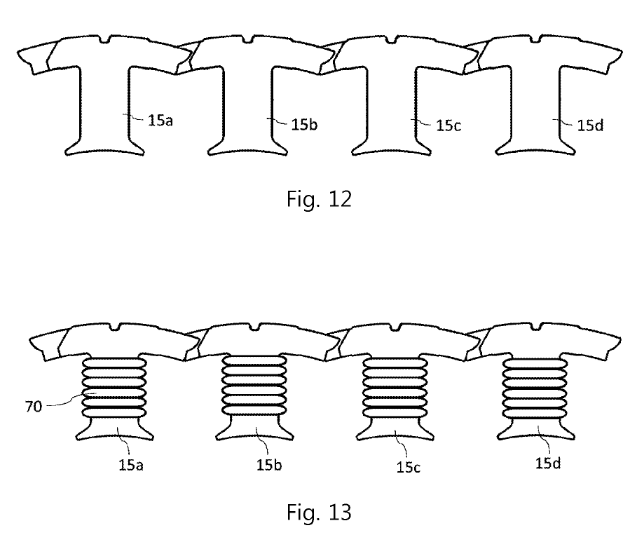

FIG. 12 is a view showing core pieces in which laminate members are laminated in a process of manufacturing a stator. When all of the laminate members are laminated (Y of S120), as shown in FIG. 12, core pieces 15a, 15b, 15c, and 15d in which the laminate members are laminated are arranged in a transverse direction. In this state, conductive wires are wound around tooth portions 40 of the core pieces 15a, 15b, 15c, and 15d, and thus a coil 70 is formed (S140). When the conductive wires are wound around the tooth portions 40 of the core pieces 15a, 15b, 15c, and 15d, the core pieces 15a, 15b, 15c, and 15d may be rotated in a direction in which tooth portions 40 of the adjacent core pieces are spaced apart from each other, and thus a wide space provided around the tooth portions 40 allows the conductive wires to be easily wound around the tooth portion 40. In this case, the circular arc-shaped protrusion 21 and the contact portion 23 of the adjacent core pieces are in contact with each other at one point, and the core pieces are rotated about a center C2 while changing a contact position. FIG. 13 is a view showing divided stators on which a coil 70 is formed by winding a conductive wire around tooth portions 40 of core pieces 15a, 15b, 15c, and 15d. When the conductive wires are wound around the tooth portions 40, the divided stators of the core pieces 15a, 15b, 15c, and 15d around which the conductive wires are wound are rotated, and the core back portions 20 are annularly connected (S150). Thus, the stator having the core 1, on which the conductive wire is wound, shown in FIG. 4 is formed.

Further, the plate member 2 used in a manufacturing configuration may not be necessarily one plate member but may be two or more plate members if so desired.

The preferred embodiments and the preferred modifications of the present invention have been described in detail. The above-descriptions are only exemplary, but the present invention is not limited thereto and may be widely interpreted within the range in which those skilled in the art understand.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator comprising:
a core in an annular shape including a center that is a vertically extending central axis; wherein
the core includes core pieces in which at least a first laminate member and a second laminate member are laminated;
the first laminate member includes a first tooth portion extending in a radial direction and a first core back portion connected to a radially outer side of the first tooth portion and extending in a circumferential direction;
the second laminate member includes a second tooth portion extending in a radial direction and a second core back portion connected to a radially outer side of the second tooth portion and extending in a circumferential direction;
positions of two circumferential ends of the first core back portion are different from positions of two circumferential ends of the second core back portion;
the first core back portion includes a first protrusion on one side thereof in a circumferential direction; and
the first protrusion is in contact with an adjacent one of the core pieces at one point.

2. The stator of claim 1, wherein:
the second core back portion includes a second protrusion at a side thereof in the circumferential direction; and
the second protrusion is in contact with another adjacent one of the core pieces at one point.

3. The stator of claim 2, wherein each of the first protrusion and the second protrusion has a circular arc shape.

4. The stator of claim 3, wherein:
the first protrusion has a circular arc shape including a center that is a position at which a bisector between a radially center line of the first tooth portion and a center line in a radial direction of a first tooth portion of the core piece adjacent thereto intersects with an outer circumferential surface of the first core back portion; and
the second protrusion includes a circular arc shape having a center that is a position at which a bisector between a radially center line of the second tooth portion and a center line in a radial direction of a second tooth portion of the core piece adjacent thereto intersects with an outer circumferential surface of the second core back portion.

5. The stator of claim 2, wherein:
the first core back portion further includes a first contact portion at another side thereof in the circumferential direction;
the second core back portion further includes a second contact portion at another side thereof in the circumferential direction;
the first protrusion is in contact with the first contact portion at one point; and
the second protrusion is in contact with the second contact portion at one point.

6. The stator of claim 5, wherein each of the first contact portion and the second contact portion have a straight shape.

7. The stator of claim 6, wherein:
the first core back portion includes a first radially straight portion extending in the radial direction on one side thereof in the circumferential direction, and a second radially straight portion extending in the radial direction on the other side thereof in the circumferential direction; and
the second core back portion includes a third radially straight portion extending in the radial direction on one side thereof in the circumferential direction, and a fourth radially straight portion extending in the radial direction on the other side thereof in the circumferential direction.

8. The stator of claim 7, wherein:
the first contact portion includes an inclined surface having an inclination of greater than or equal to about 130 degrees to less than or equal to about 140 degrees with respect to the first radially straight portion; and
the second contact portion includes an inclined surface having an inclination of greater than or equal to about 130 degrees to less than or equal to about 140 degrees with respect to the third radially straight portion.

9. The stator of claim 1, wherein an overlapping area of the first core back portion and the second core back portion of the core piece adjacent thereto overlapping in a lamination direction is greater than a circumferential cross-sectional area of the first core back portion.

10. The stator of claim 1, wherein
the core piece includes a third laminate member further laminated therein;
the third laminate member includes a third tooth portion extending in a radial direction and a third core back portion connected to a radially outer side of the third tooth portion and extending in a circumferential direction;
positions of circumferential ends of the second core back portion are different from positions of circumferential ends of the third core back portion;
the third core back portion includes a third protrusion on one side thereof in the circumferential direction; and
a distance between the first core back portion and the second core back portion of one of the core pieces adjacent thereto in a lamination direction is different from a distance between the second core back portion and the third core back portion of one of the core pieces adjacent thereto in a lamination direction.

11. The stator of claim 10, wherein a distance between the first core back portion and the second core back portion of the core piece adjacent thereto in a lamination direction is greater than or equal to about 5 to less than or equal to about 20 μm.

12. The stator of claim 5, wherein:
the first core back portion has an inclined or curved shape at a lower side of one side thereof in the circumferential direction overlapping the core piece adjacent thereto or the other side thereof in the circumferential direction; and
the second core back portion has an inclined or curved shape at a lower side of the other side thereof in the circumferential direction overlapping the core piece adjacent thereto or one side thereof in the circumferential direction.

13. The stator of claim 5, wherein:
the first core back portion includes a first protrusion or a first recess in a lamination direction on one side thereof in the circumferential direction overlapping the core piece adjacent thereto or the other side thereof in the circumferential direction;
the second core back portion includes a second recess or a second protrusion in a lamination direction on the other side thereof in the circumferential direction overlapping the adjacent core piece adjacent thereto or one side thereof in the circumferential direction; and
the first protrusion and the second recess or the first recess and the second protrusion are engaged with each other.

14. The stator of claim 1, wherein:
the first core back portion includes a first central recess incised inward in the radial direction at a position at which the outer circumferential surface and an extended line of the center line of the first tooth portion intersect each other; and
the second core back portion includes a second central recess incised inward in the radial direction at a position at which the outer circumferential surface and an extended line of the center line of the second tooth portion intersect each other.

15. A motor comprising the stator of claim 1.

16. A method of manufacturing a stator including a core in an annular shape including a center that is a vertically extending central axis and a conductive wire that is wound around the core, the method comprising:
separating a plurality of first laminate members disposed in parallel or substantially in parallel in a first direction from a plate member;
separating a plurality of second laminate members disposed in parallel or substantially in parallel in the first direction from the plate member and laminating the plurality of second laminate members on the plurality of first laminate members so that a first tooth portion and a second tooth portion overlap each other;
winding a conductive wire around teeth including the first tooth portion and the second tooth portion overlapping each other; and
connecting divided stators, which are disposed in parallel or substantially in parallel in the first direction and around which the conductive wire are wound, in an annular shape by rotating the divided stators; wherein
the core includes core pieces in which at least the first laminate member and second laminate member are laminated;
the first laminate member of the core piece includes a first tooth portion extending in a radial direction, and a first core back portion connected to a radially outer side of the first tooth portion and extending in a circular arc shape;
the second laminate member of the core piece includes a second tooth portion extending in the radial direction, and a second core back portion connected to a radially outer side of the second tooth portion and extending in a circular arc shape;
positions of circumferential ends of the first core back portion are different from positions of circumferential ends of the second core back portion;
the first core back portion includes a first protrusion formed on one side thereof in a circumferential direction and a first straight portion formed on another side thereof in the circumferential direction; and
the second core back portion includes a second straight portion formed on one side thereof in the circumferential direction and a second protrusion formed on another side thereof in the circumferential direction.
